(19) United States
(12) Patent Application Publication
(10) Pub. No.: US 2014/0055615 A1
(43) Pub. Date: Feb. 27, 2014

(54) PARKING ASSISTANT DEVICE

(71) Applicant: Stephen CHEN, Changhua (TW)

(72) Inventor: Stephen CHEN, Changhua (TW)

(21) Appl. No.: 13/594,872

(22) Filed: Aug. 27, 2012

(51) Int. Cl. B60Q 1/48; H04N 7/18

(52) U.S. Cl. 348/148; 340/932.2; 348/E07.085

(57) ABSTRACT

A parking assistant device is built in with a parking-path planning software which is capable of calculating a parking path based on a selected parking mode, the only thing that the driver needs to do, during parking, simply involves turning the steering wheel to the extreme left, right and to the center, and driving the vehicle forward and backward, the parking operation is very simple, so that the possibility of error operation can be reduced to the least. Furthermore, the parking assistant of just provides assistant in parking, it does not require the use of complicated control system or devices, and therefore, the cost of the present invention is relatively low, which arouses the consumers' desire to buy the products.

### BACKGROUND OF THE INVENTION

1. Field of the Invention

The present invention relates to the parts of a vehicle, and more particularly to a parking assistant device.

2. Description of the Prior Art

Reverse parking is one of the relatively difficult driving activities during driving, therefore, various parking assistant systems appeared on the market. One of the popular parking assistant systems is usually provided with parking sensors to detect the obstacles behind the host vehicle so as to prevent scratching. Or, cameras are disposed on the rear of the vehicle to take images of the area behind the vehicle, the images taken by the cameras are displayed on the display unit inside the vehicle for allowing the driver to view the condition behind the vehicle during reverse parking. On the display unit is designed a target parking frame which is to be aligned with the parking space. The parking assistant system just assists the driver in parking without providing further help.

Some of the luxury vehicles are equipped with an automatic parking system which uses ultrasonic to measure the parking space, the vehicle with the automatic parking system can be parked automatically by the vehicle itself, the only thing that the driver needs to do, during parking, is to step on the brake. In other words, the control of the vehicle completely relies on the automatic parking system, which will also increase the possibility of error operation since the real driving environment is usually ignored. Furthermore, to possess the automatic parking function, the automatic parking system inevitably has a complicated structural and therefore is relatively expensive.

The present invention has arisen to mitigate and/or obviate the afore-described disadvantages.

### SUMMARY OF THE INVENTION

The primary object of the present invention is to provide a parking assistant device which is capable of assisting the driver in parking a vehicle safely and quickly, and the control of the vehicle is still in the driver's hands.

To achieve the above object, a parking assistant device used in combination with a vehicle audio system of a vehicle and comprises: a CPU (central processing unit), an image output port, a parking mode selecting unit, a monitoring module, a displacement-detecting unit, and a voice prompt unit. The vehicle audio system comprises a display.

The central processing unit includes a parking-path planning software and a path-selecting button, the path-selecting button is used to control the CPU and select a parking mode.

The image output port serves to output images and reversing signals and has one end connected to an image input terminal of the vehicle audio system and has another end connected to the CPU. When a driver turns on the parking assistant device, images and reversing signals are outputted from the image output port, so that the vehicle audio system will detect that the vehicle is in a reverse state and consequently switch a status of image input source to a status of reverse parking image input terminal.

The parking mode selecting unit is stored in and controlled by the CPU, an index mark indicating the parking mode selected by the path-selecting button is displayed on the display, and the parking mode selecting unit is controlled by the path-selecting button to move the index mark.

The monitoring module is electrically connected to the CPU and comprises a rear view camera unit, two lateral cameras and an image switching unit. The rear view camera unit is disposed at a rear end of the vehicle to monitor the area behind the vehicle, the lateral cameras are disposed at both sides of the vehicle to monitor the areas at both sides of the vehicle, the image switching unit is electrically connected to and controlled by the CPU to switch the display to display images taken by the rear view camera unit or the lateral cameras.

The displacement-detecting unit is electrically connected to the CPU to calculate a displacement of the vehicle.

### BRIEF DESCRIPTION OF THE DRAWINGS

FIG. 1 is a flow chart showing a parking assistant device in accordance with a first preferred embodiment of the present invention;

FIG. 2 is an illustrative view showing that the parking assistant device in accordance with the present invention is used in parallel reverse parking;

FIG. 3 is another illustrative view showing that the parking assistant device in accordance with the present invention is used in parallel reverse parking;

FIG. 4 is a flow chart showing a parking assistant device in accordance with a second preferred embodiment of the present invention;

FIG. 5 is a flow chart showing a parking assistant device in accordance with a third preferred embodiment of the present invention;

FIG. 6 is an illustrative view showing that the parking assistant device in accordance with the present invention is used in a perpendicular reverse parking; and

FIG. 7 is another illustrative view showing that the parking assistant device in accordance with the present invention is used in a perpendicular reverse parking.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

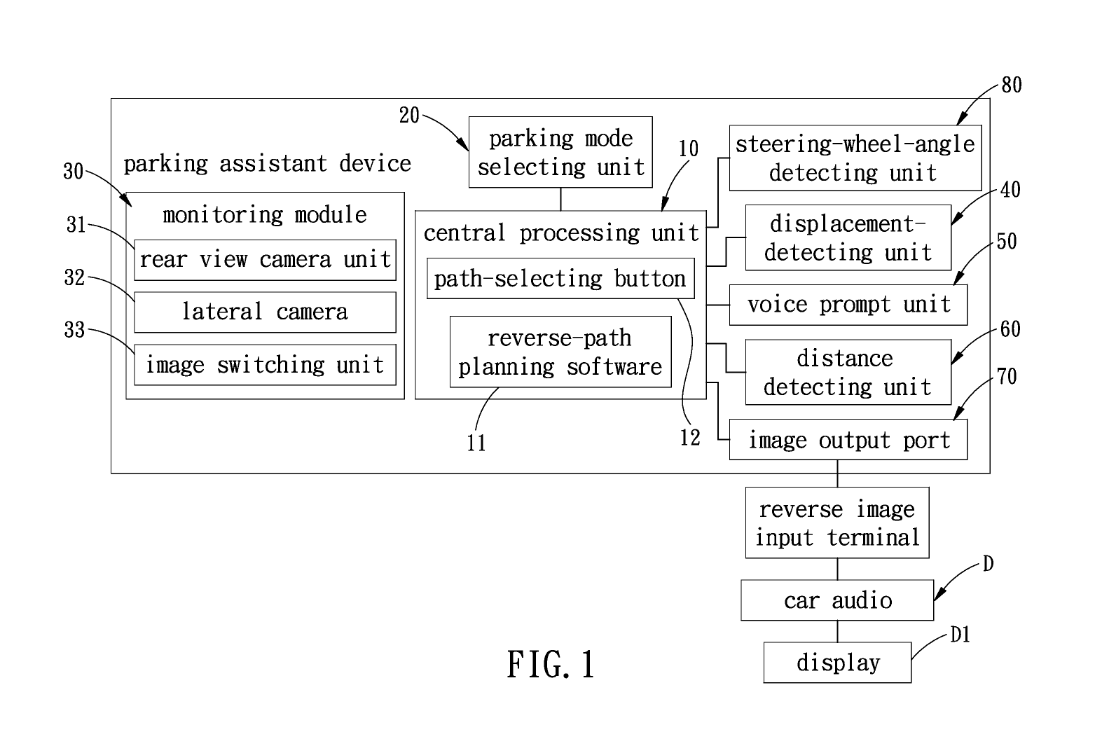

Referring to FIGS. 1-3, a parking assistant device in accordance with a first preferred embodiment of the present invention is used in combination with a vehicle audio system D of a vehicle A and comprises a CPU (central processing unit) 10, an image output port 70, a parking mode selecting unit 20, a monitoring module 30, a displacement-detecting unit 40, and a voice prompt unit 50. The vehicle audio system D comprises a display D1.

The CPU 10 comprises a parking-path planning software 11 and a path-selecting button 12. The path-selecting button 12 is used to control the CPU 10 and select a parking mode which can be a leftward parallel reverse parking mode, a rightward parallel reverse parking mode, a leftward perpendicular parking mode or a rightward perpendicular parking mode.

The image output port 70 serves to output image and reversing signals and has one end connected to an image input terminal of the vehicle audio system D and has another end connected to the CPU 10. The image processed by the CPU 10 is transmitted to and displayed on the display D1 by the image output port 70. When the driver turns on the parking assistant device, images and reversing signals are outputted from the image output port 70, so that the vehicle audio system D will detect that the vehicle A is in a reverse state and consequently switch the image input source to the reverse parking image input terminal.

The parking mode selecting unit 20 is stored in and controlled by the CPU 10. An index mark M indicating the parking modes which are to be selected by the path-selecting button 12 is displayed on the display D1. The index mark M includes a movable target parking frame M1 and an obstacle frame M2. The driver can move the target parking frame M1 to a desired position where the vehicle is to be parked, then the parking-path planning software 11 calculates an optimum virtual parking path based on the selected parking mode and the desired position to which the target parking frame M1 moved. It is to be noted the driver will be reminded that the obstacle frame M2 should not be overlapped with the rear wheels, when the driver moves the target parking frame M1.

The monitoring module 30 is electrically connected to the CPU 10 and comprises a rear view camera unit 31, two lateral cameras 32 and an image switching unit 33.

The rear view camera unit 31 is disposed at the rear end of the vehicle to monitor the area behind the vehicle.

The lateral cameras 32 are disposed at both sides of the vehicle to monitor the areas at both sides of the vehicle.

The image switching unit 33 is electrically connected to and controlled by the CPU 10 to switch image, namely, the display D1 of the vehicle audio system D is switched by the image switching unit 33 to display the images taken by the rear view camera unit 31 or the lateral cameras 32.

The displacement-detecting unit 40 is electrically connected to the CPU 10 to calculate the displacement of the vehicle, and the displacement-detecting unit 40 can be a gyroscope or connected to a speed sensor provided on the vehicle A.

When the displacement-detecting unit 40 is a gyroscope, the CPU 10 can calculate the displacement of the vehicle by multiplying the turning angle of the vehicle detected by the gyroscope by the turning radius of the vehicle A.

If the displacement-detecting unit 40 is a speed sensor, the CPU 10 calculates the displacement of the vehicle A by multiplying the speed of the vehicle A detected by the speed sensor by the length of time that the vehicle A traveled.

The parking assistant device in accordance with the present invention further includes a steering-wheel-angle detecting unit 80 which is electrically connected to the CPU 10 to detect the rotation angle of the steer wheel by receiving the rotation angle signal from the steer wheel or based on the rotation angle of the vehicle detected by the gyroscope and the speed of the vehicle. If no speed of the vehicle is detected, an acceleration sensor can also be used in combination with the gyroscope to detect the rotation angle of the steering wheel.

The steering-wheel-angle detecting unit 80 also serves to detect whether the driver turns the steering wheel to the center, or to the extreme left or right. When the steering-wheel-angle detecting unit 80 detects that the driver fails to turn the steering wheel or drive the vehicle to the direction as guided by the automatic parking system, the parking instruction is cancelled immediately.

The parking assistant device in accordance with the present invention further includes a voice prompt unit 50 electrically connected to and controlled by the CPU 10.

The parking mode selecting unit 20 further comprises a prompt which uses countdown numbers or lights that go out one by one to prompt the driver. For example, when the vehicle is approaching the turning point, the parking mode selecting unit 20 starts to count down in numbers 5, 4, 3, 2, 1, 0, when it counts down to 0, it means that the vehicle is right at the turning point. Or, there are lights, and the lights go out one by one, when all the lights go out, it means that the vehicle is right at the turning point, so that the driver can decelerate the vehicle to prepare for the next operation.

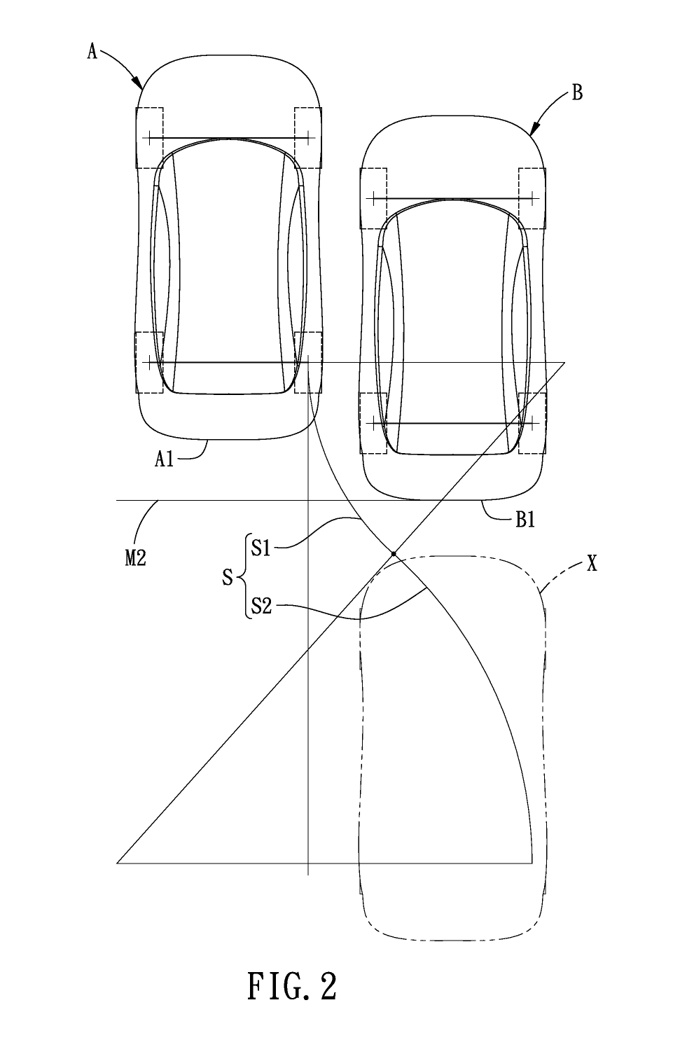

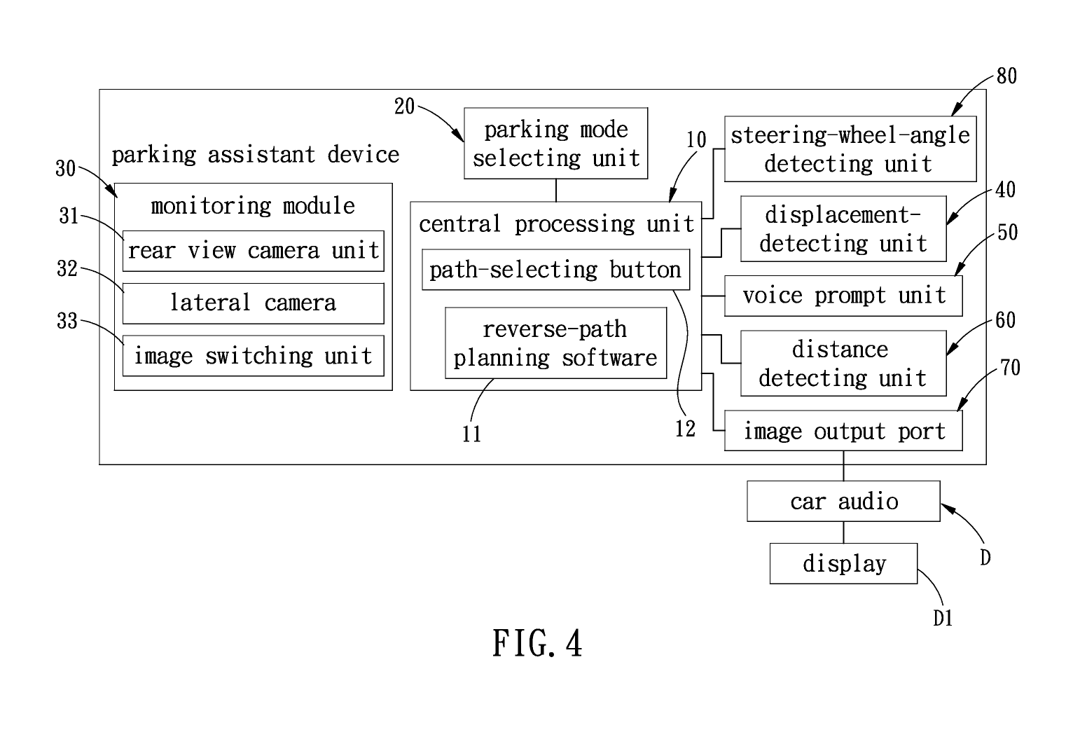

As shown in FIGS. 2-4, a parking assistant device in accordance with a second preferred embodiment of the present invention is used in combination with a vehicle audio system D of a vehicle A and comprises a CPU (central processing unit) 10, an image output port 70, a parking mode selecting unit 20, a monitoring module 30, a displacement-detecting unit 40, and a voice prompt unit 50. The vehicle audio system D comprises a display D1.

The CPU 10 comprises a parking-path planning software 11 and a path-selecting button 12. The path-selecting button 12 is used to control the CPU 10 and select a parking mode.

The image output port 70 has one end connected to an image input terminal of the vehicle audio system D and has another end connected to the CPU 10. Images are displayed on the display D1 by the image output port 70. When the vehicle audio system D detects an image synchronization signal at the image output port 70, it will switch the image input source to the reverse parking image input terminal.

The parking mode selecting unit 20 is stored in and controlled by the CPU 10. Index mark M indicating the parking modes which are to be selected by the path-selecting button 12 is displayed on the display D1. The index mark M includes a movable target parking frame M1 and an obstacle frame M2. The driver can move the target parking frame M1 to a desired position where the vehicle is to be parked, then the parking-path planning software 11 calculates an optimum virtual parking path based on the selected parking mode and the desired position to which the target parking frame M1 moved. It is to be noted the driver that the obstacle frame M2 should not be overlapped with the rear wheels, when the driver moves the target parking frame M1.

The monitoring module 30 is electrically to the CPU 10 and comprises a rear view camera unit 31, two lateral cameras 32 and an image switching unit 33. The lateral cameras 32 are disposed at both sides of the vehicle to monitor the areas at both sides of the vehicle. The image switching unit 33 is controlled by the CPU 10 to switch image, namely, the display D1 of the vehicle audio system D is switched by the image switching unit 33 to display the images taken by the rear view camera unit 31 or the lateral cameras 32.

The displacement-detecting unit 40 is electrically connected to the CPU 10 to calculate the displacement of the vehicle, and the displacement-detecting unit 40 provides detected information to the CPU 10 to let the CPU 10 compares the detected information with the optimum parking path.

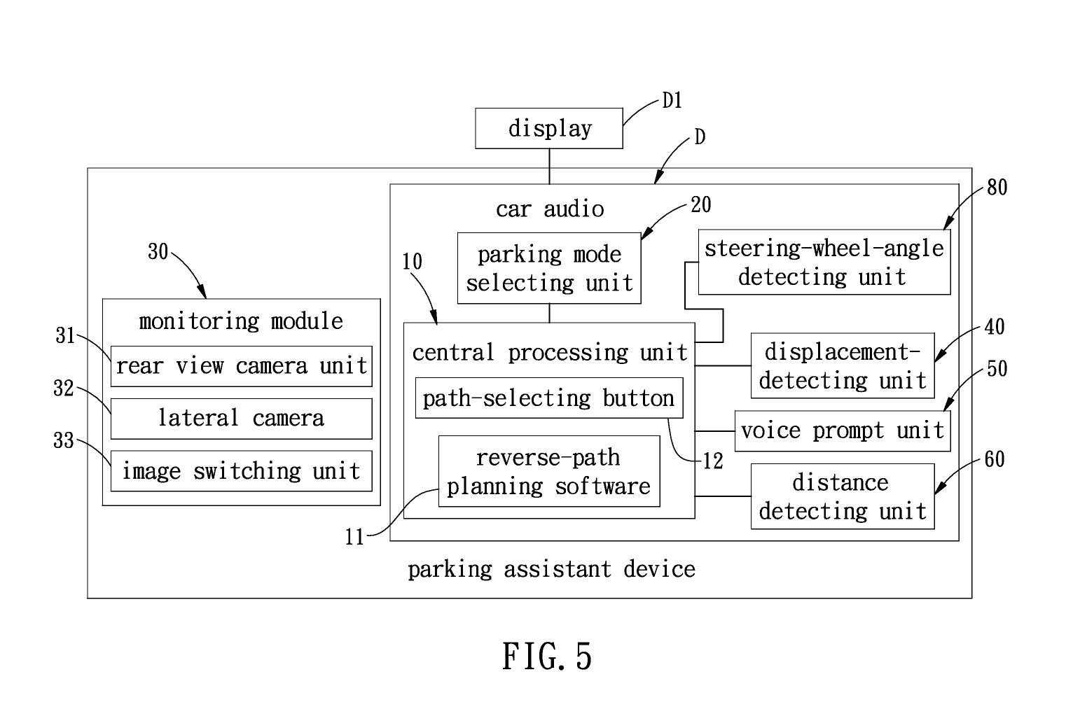

Referring then to FIGS. 2, 3 and 5, a parking assistant device in accordance with a third preferred embodiment of the present invention comprises a vehicle audio system D which comprises a display D1, a CPU (central processing unit) 10, an image output port 70, a parking mode selecting unit 20, a monitoring module 30, and a displacement-detecting unit 40.

The CPU 10 comprises a parking-path planning software 11 and a path-selecting button 12. The path-selecting button 12 is used to control the CPU 10 and select a parking mode.

The parking mode selecting unit 20 is stored in and controlled by the CPU 10. An index mark M indicating the parking modes which are to be selected by the path-selecting button 12 is displayed on the display D1. The index mark M includes a movable target parking frame M1 and an obstacle frame M2. The driver can move the target parking frame M1 to a desired position where the vehicle is to be parked, then the parking-path planning software 11 calculates an optimum virtual parking path based on the selected parking mode and the desired position to which the target parking frame M1 moved. It is to be noted the driver that the obstacle frame M2 should not be overlapped with the rear wheels, when the driver moves the target parking frame M1.

The monitoring module 30 is electrically to the CPU 10 and comprises a rear view camera unit 31, two lateral cameras 32 and an image switching unit 33. The lateral cameras 32 are disposed at both sides of the vehicle to monitor the areas at both sides of the vehicle. The image switching unit 33 is controlled by the CPU 10 to switch image, namely, the display D1 of the vehicle audio system D is switched by the image switching unit 33 to display the images taken by the rear view camera unit 31 or the lateral cameras 32.

The displacement-detecting unit 40 is electrically connected to the CPU 10 to calculate the displacement of the vehicle, and the displacement-detecting unit 40 provides detected information to the CPU 10 to let the CPU 10 compares the detected information with the optimum parking path.

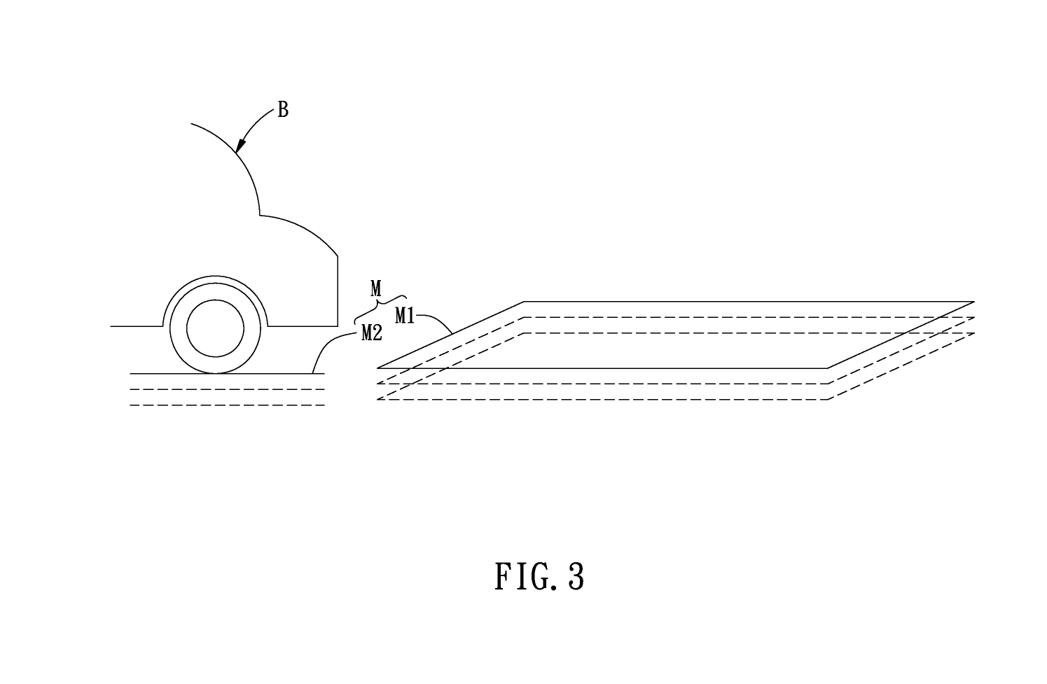

For example, when the driver wants to park the vehicle A in the parking space X behind a adjacent vehicle B by way of parallel reverse parking, the vehicle A should be firstly stopped beside the adjacent vehicle B in a parallel manner with the tail A1 of the vehicle A facing toward the parking space X. Then, the driver turns on the parking assistant device, and the CPU 10 starts to do parking assistant by sending out a reversing signal or an image synchronization signal to the vehicle audio system D, so that the display D1 is switched to display the reverse parking video. At this moment, the driver can use the image switching unit 33 to switch the display D1 to display the images taken by the lateral cameras 32. Meanwhile, the display D1 also displays the parking mode selecting unit 20 to allow the driver to choose a parking mode using the path-selecting button 12. An index mark M corresponding to the parking modes is displayed on the display D1 by the parking mode selecting unit 20. The driver then uses the image switching unit 33 to switch the display D1 to display the images taken by the lateral cameras 32, as shown in FIG. 3, wherein the movable target parking frame M1 of the index mark M is in parallel to the lateral side of the adjacent vehicle B, and the obstacle frame M2 is in parallel to the edge of the wheels of the adjacent vehicle B. Then, the users can use the path-selecting button 12 to move the target parking frame M1 to a desired position where the vehicle is to be parked, and the target parking frame M1 will show a corresponding obstacle frame M2. When moving the target parking frame M1, the driver will be reminded that the obstacle frame M2 should not be overlapped with the rear wheels of the adjacent vehicle B. After the driver moves the target parking frame M1 to the desired position, then the parking-path planning software 11 calculates an optimum virtual parking path S based on the selected parking mode. As shown in FIG. 2, the virtual parking path S includes a first path S1 and a second path S2.

At this moment, the driver reverses the vehicle A in a straight line, when the vehicle A keep moving reversely, the obstacle frame M2 displayed on the display D1 also moves simultaneously with the vehicle A. When the obstacle frame M2 is overlapped with the tail B1 of the vehicle B, it means that the vehicle A arrives at the start point of the optimum virtual parking path S. Then, the CPU 10 controls the voice prompt unit 50 to send out a prompt sound to remind the driver to be ready for next operation. Meanwhile, the CPU 10 also can control the display D1 to display prompt information in the form of character or patterns.

When the parking assistant device in accordance with the present invention sends out a prompt to remind the driver to be ready for the next operation, (the next operation is to turn the steering wheel to the extreme toward the parking space X, and the vehicle A keeps moving), the displacement-detecting unit 40 will detect the displacement and turning angle of the vehicle A. When the displacement-detecting unit 40 detects that the path that the vehicle A travelled is in compliance with the first path S1 of the optimum virtual parking path S, the CPU 10 will control the voice prompt unit 50 to send out a prompt to remind the driver to be ready for the next operation. During the reverse parking, if the driver fails to turn the steering wheel by the angle as guided by the parking assistant device, the instruction of parking assistant provided by the parking assistant device is cancelled immediately, and the driver has to park the vehicle by himself without the assistant of the parking assistant device.

When the voice prompt unit 50 sends out the prompt, it means that the vehicle A has finished moving along the first path S1, the driver has to turn the steering wheel reversely to the extreme (in a direction opposite the direction of the parking space), the displacement-detecting unit 40 will detect the displacement and turning angle of the vehicle A. When the displacement-detecting unit 40 detects that the path that the vehicle A travelled is in compliance with the second path S2 of the optimum virtual parking path S, the CPU 10 will control the voice prompt unit 50 to send out a prompt to remind the driver that the vehicle A has been parked in the parking space, then the driver turns the steering wheel to the center, and thus the parking is done.

The movable target parking frame M1 displayed on the parking mode selecting unit 20 is used as a reference base to measure the distance between the vehicle A and the adjacent vehicle B. Or, a distance detecting unit 60 can be disposed at a lateral side of the vehicle A and electrically connected to the CPU 10 to detect the distance between the vehicle A and the adjacent vehicle B. The parking-path planning software 11 is able to calculate an optimum virtual parking path and the obstacle frame M2 as well, based on the detected distance between the vehicle A and the adjacent vehicle B, and the obstacle frame M2 will be displayed on the display D1.

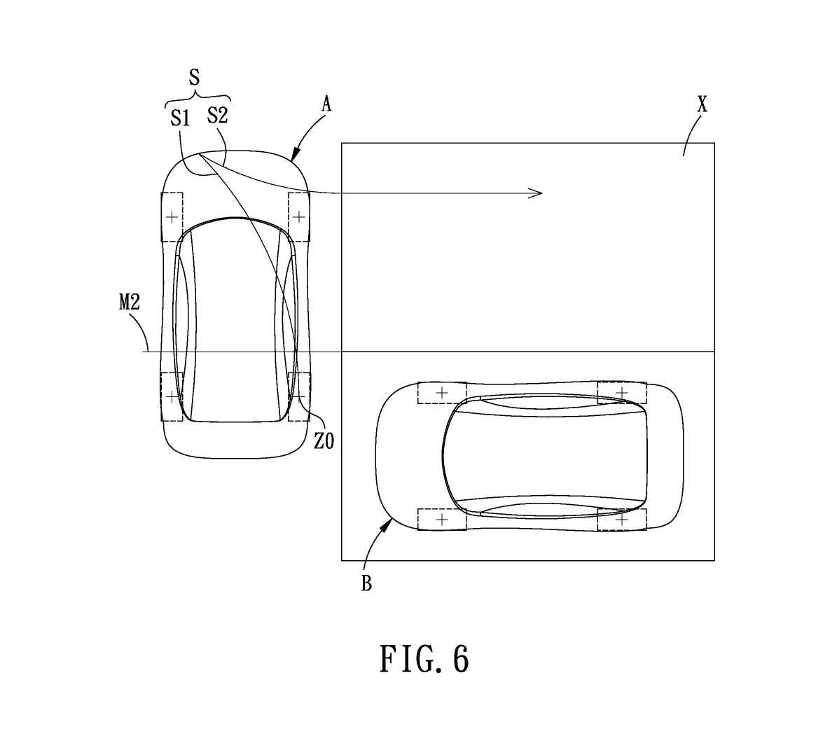

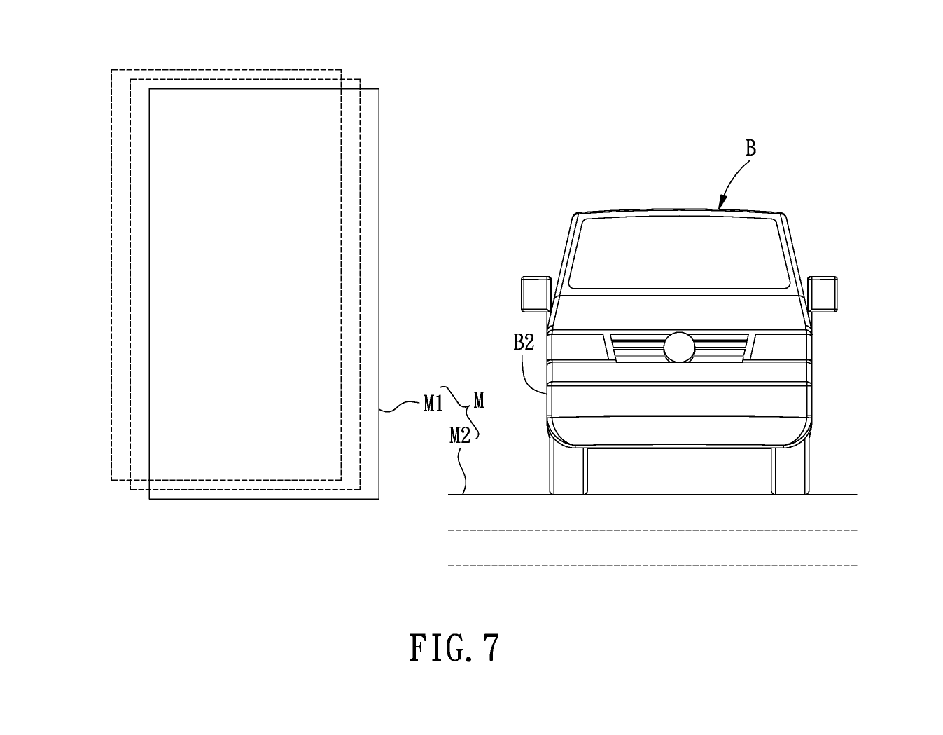

The abovementioned parking is described by taking an example where the vehicle A is in parallel to the parking space X. When the vehicle A is perpendicular to the parking space, as shown in FIGS. 6 and 7, the parking method will approximately be the same and is to be described as follows:

Firstly, the vehicle A stops perpendicular to the parking space X, and the parking space X is located to the left of the vehicle A. Then, the driver turns on the parking assistant device, and the CPU 10 starts to do parking assistant by sending out a reversing signal or an image synchronization signal to the vehicle audio system D, so that the display D1 is switched to display the reverse parking video. At this moment, the driver can use the image switching unit 33 to switch the display D1 to display the images taken by the rear view camera unit 31. Meanwhile, the display D1 also displays the parking mode selecting unit 20 to allow the driver to choose a parking mode using the path-selecting button 12. The index mark M corresponding to the parking modes is displayed on the display D1 by the parking mode selecting unit 20. The driver then uses the image switching unit 33 to switch the display D1 to display the images taken by the lateral cameras 32 or by the rear view camera unit 31, as shown in FIG. 7, wherein the movable target parking frame M1 of the index mark M is approximately in parallel to the lateral side of the adjacent vehicle B, and the obstacle frame M2 is in parallel to the edge of the wheels of the adjacent vehicle B. Then, the users can use the path-selecting button 12 to move the target parking frame M1 to a desired position where the vehicle is to be parked, and the target parking frame M1 will show a corresponding obstacle frame M2. When moving the target parking frame M1, the driver will be reminded that the obstacle frame M2 should not be overlapped with the rear wheels of the adjacent vehicle B. After the driver moves the target parking frame M1 to the desired position, then the parking-path planning software 11 calculates an optimum virtual parking path S based on the selected parking mode. As shown in FIG. 6, the virtual parking path S includes a first path S1 and a second path S2.

At this moment, the driver firstly stops the vehicle A in a direction perpendicular to the parking space X, and then continues to move the vehicle A, the obstacle frame M2 displayed on the display D1 also moves simultaneously with the vehicle A. When the obstacle frame M2 is overlapped with the lateral side B2 of the vehicle B, it means that the vehicle A arrives at the start point of the optimum virtual parking path S. Then, the CPU 10 controls the voice prompt unit 50 to send out a prompt sound to remind the driver to be ready for next operation. Meanwhile, the CPU 10 also can control the display D1 to display prompt information in the form of character or patterns.

When the parking assistant device in accordance with the present invention sends out a prompt to remind the driver to be ready for the next operation, (the next operation to be carried out by driver is to turn the steering wheel to the extreme in a direction opposite to the parking space X, and the vehicle A keeps moving forward), the displacement-detecting unit 40 will detect the displacement and turning angle of the vehicle A. When the displacement-detecting unit 40 detects that the path that the vehicle A travelled is in compliance with the first path S1 of the optimum virtual parking path S, the CPU 10 will control the voice prompt unit 50 to send out a prompt to remind the driver to be ready for the next operation. During the reverse parking, if the driver fails to turn the steering wheel by the angle as guided by the parking assistant device, the instruction of parking assistant provided by the parking assistant device is cancelled immediately, and the driver has to park the vehicle by himself without the assistant of the parking assistant device.

When the voice prompt unit 50 sends out the prompt, it means that the vehicle A has finished moving along the first path S1, the driver has to turn the steering wheel reversely to the extreme (in a direction toward the parking space) and reverse the vehicle A, the displacement-detecting unit 40 will detect the displacement and turning angle of the vehicle A. When the displacement-detecting unit 40 detects that the path that the vehicle A travelled is in compliance with the second path S2 of the optimum virtual parking path S, the CPU 10 will control the voice prompt unit 50 to send out a prompt to remind the driver that the vehicle A has been parked in the parking space X, then the driver turns the steering wheel to the center, and thus the parking is done.

The movable target parking frame M1 displayed on the parking mode selecting unit 20 is used as a reference base to measure the distance between the vehicle A and the adjacent vehicle B. Or, a distance detecting unit 60 can be disposed at a lateral side of the vehicle A and electrically connected to the CPU 10 to detect the distance between the vehicle A and the adjacent vehicle B. The parking-path planning software 11 is able to calculate an optimum virtual parking path and the obstacle frame M2 as well, based on the detected distance between the vehicle A and the adjacent vehicle B, as shown in FIG. 9, and the obstacle frame M2 will be displayed on the display D1.

It is known from the above description that, with the aid of the parking assistant device of the present invention, the operation that the driver is required to do simply includes turning the steering wheel to the extreme left, right and to the center, and driving the vehicle forward and backward, the parking operation is very simple, so that the possibility of error operation can be reduced to the least. Furthermore, the parking assistant of the present invention just provides assistant in parking, the control of the vehicle A is still in the driver's hands. In other words, the parking assistant device of the present invention doesn't need to operates the vehicle, therefore, it does not require the use of complicated control system or devices, and therefore, the cost of the present invention is relatively low, which arouses the consumers' desire to buy the products of the present invention.

While we have shown and described various embodiments in accordance with the present invention, it is clear to those skilled in the art that further embodiments may be made without departing from the scope of the present invention.

What is claimed is:

1. A parking assistant device used in combination with a vehicle audio system of a vehicle, the vehicle audio system comprising a display, the parking assistant device comprising:
a central processing unit including a parking-path planning software and a path-selecting button, the path-selecting button being used to control the CPU and select a parking mode;
an image output port serving to output images and reversing signals and having one end connected to an image input terminal of the vehicle audio system and having another end connected to the CPU, when a driver turns on the parking assistant device, images and reversing signals are outputted from the image output port, so that the vehicle audio system will detect that the vehicle is in a reverse state and consequently switch a status of image input source to a status of reverse parking image input terminal;
a parking mode selecting unit stored in and controlled by the CPU, an index mark indicating the parking mode selected by the path-selecting button being displayed on the display, the parking mode selecting unit being controlled by the path-selecting button to move the index mark;
a monitoring module electrically to the CPU and comprising a rear view camera unit, two lateral cameras and an image switching unit, the rear view camera unit being disposed at a rear end of the vehicle to monitor the area behind the vehicle, the lateral cameras being disposed at both sides of the vehicle to monitor the areas at both sides of the vehicle, the image switching unit being electrically connected to and controlled by the CPU to switch the display to display images taken by the rear view camera unit or the lateral cameras; and
a displacement-detecting unit electrically connected to the CPU to calculate a displacement of the vehicle.

2. The parking assistant device as claimed in claim 1 further comprising a voice prompt unit electrically connected to and controlled by the CPU.

3. The parking assistant device as claimed in claim 1, wherein the displacement-detecting unit is a gyroscope.

4. The parking assistant device as claimed in claim 1, wherein the vehicle is equipped with a speed sensor which is connected to the displacement-detecting unit.

5. The parking assistant device as claimed in claim 1, wherein the CPU is connected to a steering-wheel-angle detecting unit.

6. The parking assistant device as claimed in claim 1, wherein the index mark is a movable target parking frame, the driver is able to move the target parking frame to a desired position where the vehicle is to be parked, then the parking-path planning software calculates a virtual parking path based on a selected parking mode and the desired position.

7. The parking assistant device as claimed in claim 1, wherein a distance detecting unit is electrically connected to the CPU to detect a distance from the vehicle to an adjacent vehicle.

8. The parking assistant device as claimed in claim 6, wherein the index mark includes an obstacle frame, the driver is reminded that the obstacle frame is not allowed to be overlapped with rear wheels of the adjacent vehicle, when the driver moves the target parking frame.

9. The parking assistant device as claimed in claim 1, wherein the parking mode selecting unit further comprises a prompt which uses countdown numbers or lights that go out one by one to prompt the driver.

10. A parking assistant device used in combination with a vehicle audio system of a vehicle, the vehicle audio system comprising a display, the parking assistant device comprising:
a central processing unit including a parking-path planning software and a path-selecting button, the path-selecting button being used to control the CPU and select a parking mode;
an image output port with one end connected to an image input terminal of the vehicle audio system and another end connected to the CPU, images being displayed on the display, when detecting an image synchronization signal at the image output port, the vehicle audio system will switch a status of image input source to a status of reverse parking image input terminal;
a parking mode selecting unit stored in and controlled by the CPU, an index mark indicating the parking mode selected by the path-selecting button being displayed on the display, the parking mode selecting unit being controlled by the path-selecting button to move the index mark;
a monitoring module electrically to the CPU and comprising a rear view camera unit, two lateral cameras and an image switching unit, the rear view camera unit being disposed at a rear end of the vehicle to monitor the area behind the vehicle, the lateral cameras being disposed at both sides of the vehicle to monitor the areas at both sides of the vehicle, the image switching unit being electrically connected to and controlled by the CPU to switch the display to display images taken by the rear view camera unit or the lateral cameras; and
a displacement-detecting unit electrically connected to the CPU to calculate a displacement of the vehicle.

11. The parking assistant device as claimed in claim 10 further comprising a voice prompt unit electrically connected to and controlled by the CPU.

12. The parking assistant device as claimed in claim 10, wherein the displacement-detecting unit is a gyroscope.

13. The parking assistant device as claimed in claim 10, wherein the vehicle is equipped with a speed sensor which is connected to the displacement-detecting unit.

14. The parking assistant device as claimed in claim 10, wherein the CPU is connected to a steering-wheel-angle detecting unit.

15. The parking assistant device as claimed in claim 10, wherein the index mark is a movable target parking frame, the driver is able to move the target parking frame to a desired position where the vehicle is to be parked, then the parking-path planning software calculates a virtual parking path based on a selected parking mode and the desired position.

16. The parking assistant device as claimed in claim 10, wherein a distance detecting unit is electrically connected to the CPU to detect a distance from the vehicle to an adjacent vehicle.

17. The parking assistant device as claimed in claim 15, wherein the index mark includes an obstacle frame, the driver is reminded that the obstacle frame is not allowed to be overlapped with rear wheels of the adjacent vehicle, when the driver moves the target parking frame.

18. A parking assistant device used in combination with a vehicle audio system of a vehicle, the vehicle audio system comprising a display, the parking assistant device comprising:
a central processing unit including a parking-path planning software and a path-selecting button, the path-selecting button being used to control the CPU and select a parking mode;
a parking mode selecting unit stored in and controlled by the CPU, an index mark indicating the parking mode selected by the path-selecting button being displayed on the display, the parking mode selecting unit being controlled by the path-selecting button to move the index mark; and
a displacement-detecting unit electrically connected to the CPU to calculate a displacement of the vehicle.

19. The parking assistant device as claimed in claim 18 further comprising a voice prompt unit electrically connected to and controlled by the CPU.

20. The parking assistant device as claimed in claim 18, wherein the displacement-detecting unit is a gyroscope.

21. The parking assistant device as claimed in claim 18, wherein the vehicle is equipped with a speed sensor which is connected to the displacement-detecting unit.

22. The parking assistant device as claimed in claim 18, wherein the CPU is connected to a steering-wheel-angle detecting unit.

23. The parking assistant device as claimed in claim 18, wherein the index mark is a movable target parking frame, the driver is able to move the target parking frame to a desired position where the vehicle is to be parked, then the parking-path planning software calculates a virtual parking path based on a selected parking mode and the desired position.

24. The parking assistant device as claimed in claim 18, wherein a distance detecting unit is electrically connected to the CPU to detect a distance from the vehicle to an adjacent vehicle.

25. The parking assistant device as claimed in claim 23, wherein the index mark includes an obstacle frame, the driver is reminded that the obstacle frame is not allowed to be overlapped with rear wheels of the adjacent vehicle, when the driver moves the target parking frame.
